(19) United States
(12) Patent Application Publication
(10) Pub. No.: US 2005/0236352 A1
(43) Pub. Date: Oct. 27, 2005

(54) Portable crane

(76) Inventor: Andrew Tien, Chino Hills, CA (US)

Correspondence Address: JOE NIEH, 18760 E. AMAR ROAD #204, WALNUT, CA, 91789, US

(21) Appl. No.: 10/830,228

(22) Filed: Apr. 22, 2004

(51) Int. Cl. B66C 23/18

(52) U.S. Cl. 212/179

(57) ABSTRACT

A portable crane that can be easily set up on the rooftop and safely and easily lift objects to the rooftop is disclosed. The portable crane comprises of a support structure that will support the portable crane near the edge of a rooftop with a boom pivotally connected to a support column affixed to the support structure and a cable extending between the free end of the boom to lift the load and a means to pull the cable such as a winch. The support structure will stabilize and support the portable crane and the load it is lifting on the edge of a rooftop.

### BACKGROUND

1. Field of Invention

The present invention relates generally to a portable crane for lifting objects. More specifically, the present invention relates to a portable crane for lifting heavy objects to the rooftop.

2. Description of Related Art

Heavy objects, such as air conditioner units and ventilation systems, often have to be lifted to the rooftop of a building for installation. If the object is small enough, it may be brought up to the rooftop through the stair well or the elevator, if available. However, more often than not, the object is either too heavy or too large to be brought up to the rooftop through the stair well or the elevator. The heavy and/or large object often has to be brought up to the rooftop from the outside of the building by lifting it directly from the ground to the rooftop.

A fixed and dedicated crane such as those used for lifting the platforms for washing windows on a large office building may be used if they are available. However, these cranes are fixed to the building as a permanent fixture and are relatively expensive. Furthermore, these fixed cranes are not practical or economical for small buildings and for single use applications such as for lifting an air conditioner unit up to the rooftop for installation.

Conventional means to lift a large and/or heavy object up to the rooftop without a fixed and dedicated crane are limited. One method is to have several people manually pull the object to the roof top. The people pulling the object will pull on a rope while standing on the rooftop to lift the object to the rooftop. This manual method requires sufficient manpower to not only lift the object but to also hold the object in mid-air when one or more person is tired or accidentally releases their grip on the rope. This method also risks damaging the side of the building if the object is dragged on or makes contact with the side of the building. Obviously this manual method risks not only damaging the object being lifted and the building but also the safety of the persons lifting the object.

The other method is to use a movable hydraulic platform that has sufficient height to raise the object to the rooftop. Obviously, this method is much safer and easier than the manual method. However, this method requires the use of an expensive movable hydraulic platform that must be delivered to the work site for use and removed from the worksite after use. Furthermore, the moveable hydraulic platform has a limited height that they can reach. This method is not feasible if the building is taller than the height of the moveable hydraulic platform when fully raised.

Yet another conventional method is to use a crane positioned on the ground adjacent to the building with sufficient reach to reach up and onto the rooftop to lift and place the object onto the rooftop. This method requires mobilization of an extremely large crane and large amount of access. This method also requires extensive setup and operation, and is expensive.

Therefore, a safe, economical, and easily portable device that can be setup and removed easily from the rooftop to lift heavy objects to the rooftop is desired and lacking.

### SUMMARY OF THE INVENTION

The present invention is a portable crane that can be easily set up on the rooftop. The portable crane can be used to safely and easily lift objects to the rooftop. The portable crane comprises of a support structure that will support the portable crane near the edge of a rooftop with a boom pivotally connected to a support column affixed to the support structure and a cable extending between the free end of the boom to lift the load and a means to pull the cable such as a winch. The support structure will stabilize and support the portable crane and the load it is lifting on the edge of a rooftop. The portable crane can be quickly set up on top of the roof and safely lift a load to the top of the roof. The portable crane can be easily moved from one rooftop to another rooftop.

### BRIEF DESCRIPTION OF THE DRAWINGS

FIG. 1 shows the preferred embodiment of the portable crane.

FIG. 2 shows another embodiment of the portable crane.

FIG. 3 shows another embodiment of the portable crane.

FIG. 4 shows application of the portable crane at the edge of a rooftop with a raised wall.

FIG. 5 shows application of the portable crane at the edge of a rooftop without a raised wall.

FIG. 6 shows application of the portable crane at the rooftop of a building adjacent to a roof access.

### DETAILED DESCRIPTION OF THE PREFERRED EMBODIMENT

The portable crane comprises of a support structure that will support the portable crane near the edge of a rooftop with a boom pivotally connected to a support column affixed to the support structure and a cable extending between the free end of the boom to lift the load and a means to pull the cable. The support structure will stabilize and support the portable crane and the load it is lifting on the edge of a rooftop. The portable crane can be quickly setup on top of the roof to safely lift a load to the top of the roof and can be easily moved from one rooftop to another rooftop.

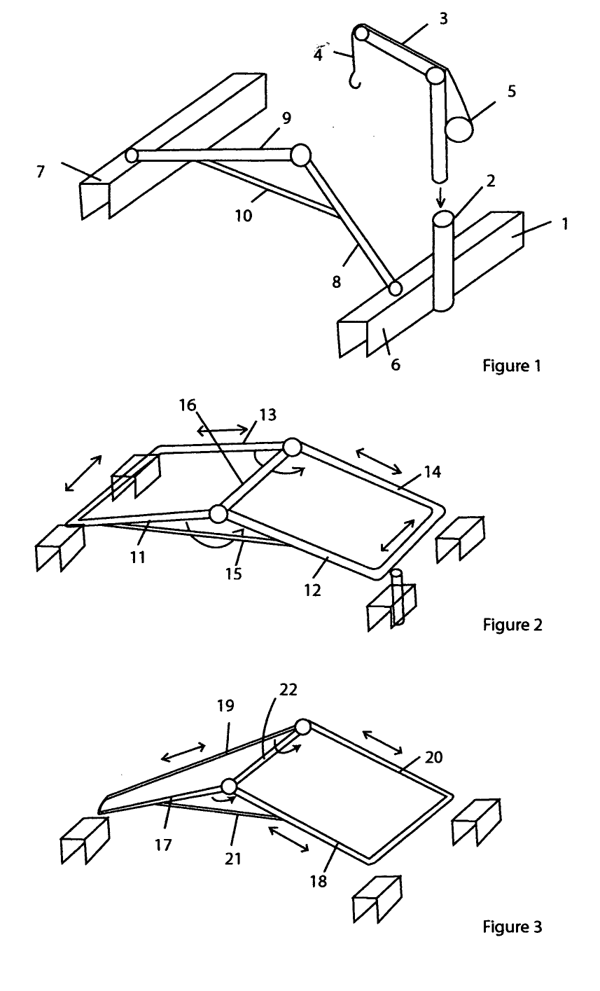

FIG. 1 shows the preferred embodiment of the portable crane. In the preferred embodiment, the portable crane comprises of a support structure 1 with one end of a support column 2 affixed to it and with a boom 3 pivotally connected to the other end of the support column 2 with a cable 4 extending between the free end of the boom 3 and a means 5 to pull the cable 4. The support column 2 may also be in two sections that may be connected to each other to form a rigid support column 2 and separate into two sections for compact and easy transportation and storage of the support structure 1 with one section of the support column and the boom 3 with the other section of the support column. The means 5 to pull the cable 4 may be a winch such as a manual or an electric winch. The support structure 1 further comprises of two base members 6, 7 that may each be in the form of an inverted channel and pivotally connected at a location between its two ends to an end of a connecting member 8 that is pivotally connected to the other connecting member 9 at the other end. Each of the connecting members 8, 9 may be of a fixed length or may be telescopically adjustable to different lengths. An adjustable locking member 10 is removably connected to a connecting member 8 at one end and to the other connecting member 9 at the other end. The adjustable locking member 10 is a telescoping member that can be adjusted to different lengths to lock the position of the two base members 6, 7 at desired positions.

FIG. 2 shows another embodiment of the portable crane. In this embodiment, two pairs of the connecting members 11, 12, 13, 14 with the adjustable locking member 15 are pivotally connected to two pairs of base members. The two pairs of the connecting members 11, 12, 13, 14 may be positioned parallel to each other with a stabilizing member 16 connecting the two pairs together at the pivot connection between the two connecting members as shown in FIG. 2.

The two pairs of the connecting members 17, 18, 19, 20 with the adjustable locking member 21 may also be positioned such that one connecting member in each pair of connecting members is positioned parallel to the other corresponding connecting member in the other pair while the other connecting member that is pivotally connected to the first connecting member is positioned such that it converges with the other corresponding connecting member from the pivot connection to a base member with a stabilizing member 22 connecting the two pairs together at the pivot connection between the two connecting members as shown in FIG. 3.

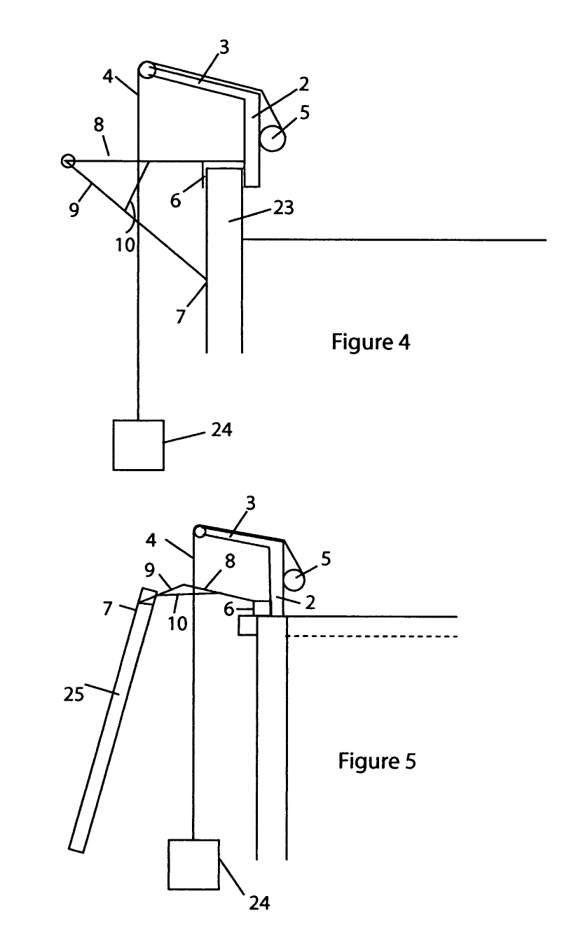

FIG. 4 shows the portable crane placed at the edge of a rooftop with a raised wall 23. The base member 6 with the support column 2 affixed to it is placed with its channel over the top of the raised wall 23. The other base member 7 is positioned and locked into position to rest against the side of the building with the adjustable locking member 10 such that the load 24 that is being lifted will be transferred to the top edge of the raised wall 23 of the roof and the side of the building and the portable crane is securely placed on the edge of the rooftop. The portable crane may then be used to lift a load 24 from the ground by pulling the cable 4 with the winch 5.

FIG. 5 shows the portable crane placed at the edge of a rooftop without a raised wall. The base member 6 with the support column 2 affixed to it is placed near the edge of the rooftop. An adjacent building or a ladder 25 may be utilized to support the other base member 7 with the adjustable locking member 10 locking the two base members 6, 7 in position to support the portable crane. In this placement, the load 24 that is being lifted will be transferred to the to top edge of the rooftop and the other adjacent building or the ladder 25 that the base member 7 is resting on and the portable crane is securely placed on the edge of the rooftop. The portable crane may then be used to lift a load 24 from the ground by pulling the cable 4 with the winch 5.

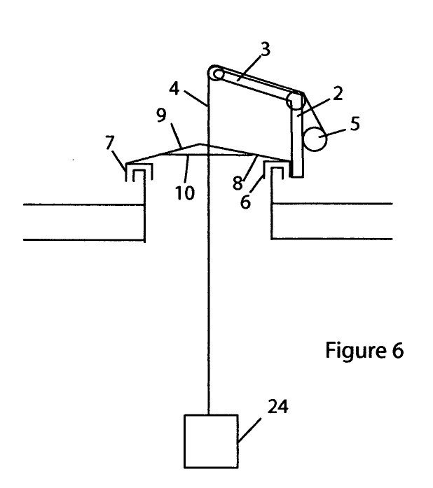

FIG. 6 shows the portable crane placed on the rooftop of a building adjacent to a roof access or ventilation opening. The base members 6, 7 are placed across the roof access or ventilation opening and resting on the rooftop with the adjustable locking member 10 locking the two base members 6, 7 in position to support the portable crane. If the roof access or ventilation opening has a raised curb that is able to support the portable crane and the load 24 that is being lifted, the portable crane may also be positioned with the two base members 6, 7 resting on the raised curb. In this placement, the load 24 that is being lifted will be transferred to the rooftop that the base members 6, 7 are resting on and the portable crane is securely positioned on the rooftop. The portable crane may then be used to lift a load 24 from the ground and through the roof access or ventilation opening by pulling the cable 4 with the winch 5.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A portable crane comprising:
a support structure comprising a first base member pivotally connected at a location between its two ends to an end of a first connecting member that is pivotally connected to a second connecting member at its other end and a second base member pivotally connected at a location between its two ends to the other end of said second connecting member and an adjustable locking member connected to said first connecting member between its two ends at one end and to the second connecting member between its two ends at the other end wherein said adjustable locking member can be adjusted to lock the position of the two base members at desired positions; and
a lifting means affixed to said support structure to lift a load;
wherein said portable crane can lift a load from the ground up to the rooftop.

2. A portable crane as in claim 1, wherein said base members are in the form of inverted U-shaped channels.

3. A portable crane as in claim 1, wherein said adjustable locking member is a telescoping member.

4. A portable crane as in claim 1, wherein said lifting means further comprising:
a support column affixed at one end to said support structure;
a boom with a free end and another end pivotally connected to the other end of the support column; and
a cable extending between the free end of said boom and a means to pull the cable.

5. A portable crane as in claim 4, wherein said support column has a first section and a second section wherein said first section may be inserted into said second section to form one rigid support column and may be separated for compact transportation and storage of the portable crane.

6. A portable crane as in claim 4, wherein said support column is a telescoping column that may be extended and contracted.

7. A portable crane as in claim 4, wherein said boom is a telescoping member that may be extended and contracted.

8. A portable crane as in claim 4, wherein said means to pull the cable is a winch.

9. A portable crane as in claim 8, wherein said winch is an electric winch.

10. A portable crane comprising:
a support structure comprising a first base member pivotally connected near an end of a first connecting member that is pivotally connected to a second connecting member at its other end and a second base member pivotally connected near the other end of said second connecting member and an adjustable locking member connected to said first connecting member between its two ends at one end and to said second connecting member between its two ends at the other end and a third base member pivotally connected near an end of a third connecting member that is pivotally connected to a fourth connecting member at its other end and a fourth base member pivotally connected near the other end of said fourth connecting member and a stabilizing member pivotally connected at one end to the connection between the first and second connecting member and at the other end to the connection between the third and fourth connecting member wherein said adjustable locking member can be adjusted to lock the position of the base members at desired positions; and
a lifting means affixed to said support structure to lift a load;
wherein said portable crane can lift a load from the ground up to the rooftop.

11. A portable crane as in claim 10, wherein said base members are in the form of inverted U-shaped channels.

12. A portable crane as in claim 10, wherein said adjustable locking member is a telescoping member.

13. A portable crane as in claim 10, wherein said lifting means further comprising:
a support column affixed at one end to said support structure;
a boom with a free end and another end pivotally connected to the other end of the support column; and
a cable extending between the free end of said boom and a means to pull the cable.

14. A portable crane as in claim 13, wherein said support column has a first section and a second section wherein said first section may be inserted into said second section to form one rigid support column and may be separated for compact transportation and storage of the portable crane.

15. A portable crane as in claim 13, wherein said support column is a telescoping column that may be extended and contracted.

16. A portable crane as in claim 13, wherein said boom is a telescoping member that may be extended and contracted.

17. A portable crane as in claim 13, wherein said means to pull the cable is a winch.

18. A portable crane as in claim 17, wherein said winch is an electric winch.

19. A portable crane comprising:
a support structure comprising a first base member pivotally connected near an end of a first connecting member that is pivotally connected to a second connecting member at its other end and a second base member pivotally connected near the other end of said second connecting member and an adjustable locking member connected to said first connecting member between its two ends at one end and to said second connecting member between its two ends at the other end and a third base member pivotally connected near an end of a third connecting member that is pivotally connected to a fourth connecting member at its other end with the other end of said fourth connecting member pivotally connected to said second base member and a stabilizing member pivotally connected at one end to the connection between the first and second connecting member and at the other end to the connection between the third and fourth connecting member wherein said adjustable locking member can be adjusted to lock the position of the base members at desired positions; and
a lifting means affixed to said support structure to lift a load;
wherein said portable crane can lift a load from the ground up to the rooftop.

20. A portable crane as in claim 19, wherein said base members are in the form of inverted U-shaped channels.

21. A portable crane as in claim 19, wherein said adjustable locking member is a telescoping member.

22. A portable crane as in claim 19, wherein said lifting means further comprising:
a support column affixed at one end to said support structure;
a boom with a free end and another end pivotally connected to the other end of the support column; and
a cable extending between the free end of said boom and a means to pull the cable.

23. A portable crane as in claim 22, wherein said support column has a first section and a second section wherein said first section may be inserted into said second section to form one rigid support column and may be separated for compact transportation and storage of the portable crane.

24. A portable crane as in claim 22, wherein said support column is a telescoping column that may be extended and contracted.

25. A portable crane as in claim 22, wherein said boom is a telescoping member that may be extended and contracted.

26. A portable crane as in claim 22, wherein said means to pull the cable is a winch.

27. A portable crane as in claim 26, wherein said winch is an electric winch.
